(19) United States
(12) Patent Application Publication
(10) Pub. No.: US 2026/0256171 A1
(43) Pub. Date: Sep. 3, 2026

(54) ENCAPSULATED COLORANT

(71) Applicant: GIVAUDAN SA, VERNIER (CH)

(72) Inventors: Theresa MATTINGLY, Cincinnati, OH (US); M.Kathleen ROUNTREE, Louisville, KY (US); Raja CHOUKET, Avignon (FR)

(21) Appl. No.: 19/165,331

(22) PCT Filed: Mar. 13, 2024
(86) PCT No.: PCT/EP2024/056607

§ 371 Date: Sep. 15, 2025

Related U.S. Application Data
(60) Provisional application No. 63/452,420, filed on Mar. 15, 2023.

(30) Foreign Application Priority Data
May 10, 2023 (GB) 2306859.6

(51) Int. Cl. A23L 5/43; A23C 21/08; A23J 3/14; A23L 29/25; A23P 10/30; B01J 13/04; C09B 61/00; C09B 67/02

(52) U.S. Cl. CPC A23L 5/43; A23C 21/08; A23J 3/14; A23L 29/25; A23P 10/30; B01J 13/043; C09B 61/00; C09B 67/0097

(57) ABSTRACT

The present invention is related to a method of improving the color stability of an oil soluble colorant in a consumable comprising adding to a consumable base an effective amount of an oil soluble colorant encapsulated with at least one of: a whey containing protein, a milk polysaccharide such as lactose and glycoprotein and/or a plant protein.

### TECHNICAL FIELD

The present disclosure relates to the use of a whey containing protein, milk polysaccharide such as lactose and glycoprotein and/or a plant protein to encapsulate an oil soluble colorant in a consumable composition to improve the color stability of the color in said consumable and a method of reducing oxidation and/or the development of off-notes of an oil soluble colorant in a consumable comprising adding to a consumable base and effective amount of an oil soluble colorant encapsulated with at least one of a whey containing protein, milk polysaccharide such as lactose and glycoprotein and/or a plant protein.

### BACKGROUND

Colour is an important attribute of finished consumable food and beverage products. It is important to maintain the recognized colour of a consumable throughout its shelf-life. Consumers would be less inclined to purchase or use a consumable that did not exhibit its customary and recognized colours, believing that there may be a quality or spoilage issue associated with such consumable.

Natural colours are more and more demanded by consumers. However, some of them may develop off notes and or loss colour intensity during storage.

### SUMMARY

In a first illustrative aspect, provided is a method of improving the color stability of an oil soluble colorant in a consumable comprising adding to a consumable base an effective amount of an oil soluble colorant encapsulated with at least one of a whey containing protein, milk polysaccharide (such as lactose and glycoprotein), and/or a plant protein.

According to a second illustrative aspect, provided is a method of reducing oxidation and/or the development of off-notes of an oil soluble colorant in a consumable comprising adding to a consumable base an effective amount of an oil soluble colorant encapsulated with at least one of a whey containing protein, milk polysaccharide (such as lactose and glycoprotein), and/or a plant protein.

According to a third illustrative aspect, provided is a method for preparing a consumable product having an improved color shelf life, a reduced oxidation, and/or reduced development of off-notes, the method comprising combining a consumable base with an effective amount of an oil soluble colorant encapsulated with at least one of a whey containing protein, milk polysaccharide (such as lactose and glycoprotein), and/or a plant protein.

According to another illustrative aspect, provided is an oil soluble colorant encapsulated using a method comprising:
a) mixing at least one of: a whey containing protein, a milk polysaccharide such as lactose and glycoprotein, and/or a plant protein, with an oil soluble colorant, and
b) spray drying the mixture of step (a) to obtain the encapsulated oil soluble color.

According to another illustrative aspect, provided is an oil soluble colorant encapsulated with at least one of: a whey containing protein, a milk polysaccharide (such as lactose and glycoprotein), and/or a plant protein.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

When a concentration is expressed as “ppm”, the concentration is parts per million by weight based on the total weight of the consumable. It should be understood that when a range of values is described in the present disclosure, it is intended that any and every value within the range, including the end points, is to be considered as having been disclosed. For example, “a range of from 1 ppm to 1000 ppm” of a component of the composition is to be read as indicating each and every possible number along the continuum between 1 and 1000. It is to be understood that the inventors appreciate and understand that any and all values within the range are to be considered to have been specified, and that the inventors have possession of the entire range and all the values within the range.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The present invention is related to an oil soluble colorant encapsulated with at least one of: a whey containing protein, a milk polysaccharide such as lactose and glycoprotein, and/or a plant protein (encapsulated colorant of the invention).

The present invention is related to a method of improving the color stability of an oil soluble colorant in a consumable comprising adding to a consumable base an effective amount of an oil soluble colorant encapsulated with at least one of a whey containing protein, a milk polysaccharide (such as lactose and glycoprotein), and/or a plant protein.

The examples of the present disclosure also show that the encapsulated oil soluble colorant according to the invention when added to a consumable reduced the appearance of off notes or off flavors after several weeks of storage. Therefore, the present invention is also directed to a method of reducing oxidation and/or the development of off-notes of an oil soluble colorant in a consumable comprising adding to a consumable base an effective amount of an oil soluble colorant encapsulated with at least one of whey containing protein, milk polysaccharide (such as lactose and glycoprotein), and/or a plant protein.

In the present invention, the term “improving the color stability” means that the colour hue provided by the encapsulated oil soluble colorant is not changed or has a change of less than 30% in respect to the colour hue measured without encapsulation, such as less than 20%, such as less than 10%, or such as less than 5% of colour hue change.

In the present invention, the term “reducing development of off-notes” means that the consumable comprising the encapsulated oil soluble colorant of the invention does not develop off notes or develop less than 30% off-notes in respect to the off-notes measured without encapsulation, such as less than 20%, such as less than 10%, or such as less than 5% off notes.

Without being bound to any theory, the off notes developed by consumables colored with the oil soluble colorants without being encapsulated according to the invention, may be produced by oxidation processed of molecules within the consumable.

The at least one oil soluble colorant used in the encapsulated colorant of the invention, in the methods of the present invention can be of natural origin, synthetic origin and combinations thereof. According to certain illustrative embodiments, the at least one oil soluble colorant used in the methods and consumables of the present invention may be selected from: one or more of Astaxanthin and Astaxanthin derivatives, bixin and annatto extracts, carotenes, including mixed carotenes, alpha carotene, beta carotene, beta-Apo-8′-carotenal, and canthaxanthin, tagetes, saffron, crocin and crocetin based colorants and their derivatives, chlorophyll containing colorants and derivatives, Carrot Oil, Corn Endosperm oil, Saffron, paprika based colorants including paprika oleoresin, capsanthin, capsorubin, lutein, astaxanthin, rubixanthin, violaxanthin, and rhodoxanthin, paracoccus pigments, red yeast and phaffia based colorants and derivatives, algal based pigments including spirulina, galdieria, kelp extract, rhodymenia palmate, gigatina and duminti extracts and concentrates, tagetes (Aztec marigold) meal and extracts, lycopene based colorants including tomato extracts, tomato concentrates, and tomato lycopene concentrate, turmeric and turmeric oleoresin and the like, microbial based pigments such as flavins, carotenoids, melanins, quinines, monascins, and violacein.

As mentioned before, said pigments may be of natural origin (obtained or obtainable form a natural source), of synthetic origin or combinations thereof. According to certain embodiments, the at least one oil soluble colorant may be from the same or different origin.

In certain embodiments, the encapsulated colorant may further comprise one or more antioxidants. The antioxidants may be of synthetic or natural origin. Without limitation, the antioxidant may be selected from one or more of BHA (butylated hydroxyanisole), BHT (butylated hydroxytoluene), Tertiary-butylhydroquinone (tBHQ), ascorbic acid (vitamin C) and it's derivatives including sodium and calcium ascorbate, and ascorbyl palmitate, vitamin E and its derivatives including but not limited to tocotrienols, alpha tocopherol and mixed tocopherols, other plant or synthetically derived phenolic compounds and their derivatives such as quercetin, resveratrol, rosmarinic acid, carnosic acid, ferulic acid, caffeic acid, coumaric acid, chlorgenic acid, ellagic acid, cinnamaldehyde, gallic acid, epigallocatechin gallate, eugenol and eugenic acid, curcumin, catechins, terpenes such as thymol, linalool, and/or carvacrol and/or their derivatives, antioxidants from plant derived compounds such as acerola cherry including acerola cherry juice, pumice, powder, or extract, including pomegranate juice, pumice, powder, or extract, spinach including spinach juice, pumice, powder, or extract, blueberry including acerola blueberry juice, pumice, powder, or extract, acai including acai juice, pumice, powder, or extract, cranberry including cranberry juice, pumice, powder, or extract, elderberry including elderberry juice, pumice, powder, or extract; selenium containing compounds such as selenomethionine, selenium selenite, selenocysteine and any of their derivatives. The antioxidant can be used alone or in combination with other antioxidants. The ratio of antioxidant to oil soluble color can vary depending on the antioxidant used and the concentration of the antioxidant molecule. In certain embodiments, it is use in the range of 50 parts oil soluble color to 1 part antioxidant to 5000 parts oil soluble color to 1 part antioxidant, such as 141 parts oil soluble color to 1 part antioxidant to 1,950 parts oil soluble color to 1 part antioxidant.

The at least one oil soluble colorant is encapsulated with at least one of: a whey containing protein, a milk polysaccharide (such as lactose and glycoprotein) and/or a plant protein (encapsulated oil soluble colorant of the invention). All different combinations of a whey containing protein, a milk polysaccharide (such as lactose and glycoprotein) and/or a plant protein are included in the present invention. For example, the oil soluble colorant may be encapsulated with a whey containing protein. For example, the oil soluble colorant may be encapsulated a milk polysaccharide (such as lactose and glycoprotein). For example, the oil soluble colorant may be encapsulated with a whey containing protein and a milk polysaccharide. For example, the oil soluble colorant may be encapsulated with a whey containing protein, a milk polysaccharide and a plant protein (such as a potato protein), etc.

“A whey containing protein” in the present invention means one or more whey containing proteins.

“A milk polysaccharide” in the present invention means one or more polysaccharide present in milk, such as lactose and glycoproteins.

“A plant protein” in the present invention means one or more plant proteins.

Any commercially available whey protein isolates or concentrates may be used for encapsulating the oil soluble colorant of the invention. In certain embodiment, the whey protein may be obtained by any process for the preparation of whey protein known in the art, as well as whey protein fractions prepared therefrom or proteins such as β-lactoglobulin (BLG), α-lactalbumin and serum albumin. In particular, sweet whey obtained as a by-product in cheese manufacture, acid whey obtained as by-product in acid casein manufacture, native whey obtained by milk microfiltration or rennet whey obtained as by-product in rennet casein manufacture may be used as the whey protein. Whey proteins may be also being produced using fermentation processes.

The whey protein may have low levels of fat and cholesterol. In certain embodiments, whey protein may also contain carbohydrates in the form of lactose.

In certain embodiments, the at least one whey protein may have been processed to remove fat and lactose.

The at least one whey protein may have more than 10% protein by dry weight, such as more than 20% w/w, more than 30% w/w, or more than 50% w/w protein by dry weight. In certain embodiments, the whey protein comprises between about 20% w/w and 89% w/w protein by dry weight.

The whey protein may be from a single source or from mixtures of any sources. In certain embodiments, whey protein may undergo hydrolysis step prior to encapsulation.

The whey protein source for the encapsulation of the colorant is not restricted to whey isolates from bovine origin, but pertains to whey isolates from all mammalian animal species, such as, without limitation, from sheep, goats, horses, and camels. Also, the manufacturing process applies to mineralized, demineralized or slightly mineralized whey preparations. By “slightly mineralized” is meant any whey preparation after elimination of free minerals which are dialyzable or diafiltrable, but which maintains minerals associated to it by natural mineralization after preparation of the whey protein concentrate or isolate, for example. These “slightly mineralized” whey preparations have had no specific mineral enrichment.

An effective amount of whey protein to be used to encapsulate the oil soluble colorant to improving the color stability of said oil soluble colorant in a consumable or to reducing oxidation and/or the development of off-notes of said oil soluble colorant in a consumable, is from about 0.01 weight percent and greater, or about 0.02 weight percent and greater, or about 0.03 weight percent and greater, or about 0.04 weight percent and greater, or about 0.05 weight percent and greater, or about 0.06 weight percent and greater, or about 0.07 weight percent and greater, or about 0.08 weight percent and greater, or about 0.09 weight percent and greater, or about 0.1 weight percent and greater, or about 0.12 weight percent and greater, or about 0.15 weight percent and greater, or about 0.17 weight percent and greater, or about 0.2 weight percent and greater, or about 0.3 weight percent and greater, or about 0.4 weight percent and greater, or about 0.5 weight percent and greater, or about 0.6 weight percent and greater, or about 0.7 weight percent and greater, or about 0.8 weight percent and greater, or about 0.9 weight percent and greater, or about 1 weight percent and greater, or about 1.1 weight percent and greater, or about 1.2 weight percent and greater, or about 1.3 weight percent and greater, or about 1.5 weight percent and greater, or about 2 weight percent and greater, or about 3 weight percent and greater, or about 4 weight percent and greater, or about 5 weight percent and greater based on the total weight of the consumable.

According to certain illustrative embodiments, an effective amount of a whey protein to be used to encapsulate the oil soluble colorant to improving the color stability of said oil soluble colorant in a consumable or to reducing oxidation and/or the development of off-notes of said oil soluble colorant in a consumable, is from about 0.1 to about 1 weight percent, such as about 0.15 to about 0.2 weight percent, such as about 0.15 to about 0.5 weight percent, such as about 0.2 to about 0.8 weight percent, such as about 0.1 to about 0.8 weight percent, such as 0.17 of the final weight of the consumable.

According to certain illustrative embodiments, an effective amount of a whey protein to be used to encapsulate the oil soluble colorant to improving the color stability of said oil soluble colorant in a consumable or to reducing oxidation and/or the development of off-notes of said oil soluble colorant in a consumable is from about 1 weight percent to about 10 weight percent based on the total weight of the consumable, or from about 2 weight percent to about 10 weight percent based on the total weight of the consumable, or from about 3 weight percent to about 10 weight percent based on the total weight of the consumable, or from about 4 weight percent to about 10 weight percent based on the total weight of the consumable, or from about 5 weight percent to about 10 weight percent based on the total weight of the consumable, or from about 6 weight percent to about 10 weight percent based on the total weight of the consumable, or from about 7 weight percent to about 10 weight percent based on the total weight of the consumable, or from about 8 weight percent to about 10 weight percent based on the total weight of the consumable, or from about 9 weight percent to about 10 weight percent based on the total weight of the consumable.

According to certain illustrative embodiments, an effective amount of a whey protein to be used to encapsulate the oil soluble colorant to improving the color stability of said oil soluble colorant in a consumable or to reducing oxidation and/or the development of off-notes of said oil soluble colorant in a consumable is from about 2 to about 8 weight percent based on the total weight of the consumable, from about 3 to about 7 weight percent based on the total weight of the consumable, or from about 4 to about 6 weight percent based on the total weight of the consumable.

A Milk polysaccharide (such as lactose and glycoprotein) may also be used for encapsulating the oil soluble colorant.

Lactose is a disaccharide derived from the condensation of galactose and glucose, which form a β-1→4 glycosidic linkage. Its systematic name is β-D-galactopyranosyl-(1→4)-D-glucose.

Any commercially available lactose isolates or concentrates may be used, i.e. lactose obtained by any process for the preparation of lactose known in the art.

Lactose isolates or concentrates may have more than 10% lactose by dry weight, such as more than 20% w/w, more than 30% w/w, or more than 50% w/w lactose by dry weight. In certain embodiments, the whey protein comprises between about 20% w/w and 89% w/w protein by dry weight. The whey protein may have low levels of fat and cholesterol. In certain embodiments, whey protein may also contain carbohydrates in the form of lactose.

In certain embodiments, Lactose isolates or concentrates may have been processed to remove fat.

The lactose may be from a single source or from mixtures of any sources.

The lactose source for the encapsulation of the colorant is not restricted to lactose isolates from bovine origin, but pertains to whey isolates from all mammalian animal species. By way of example, and not in limitation, the lactose can be obtained or obtainable from bovines, sheep, goats, horses, and camels milk.

As will be appreciated by the person skilled in the art, as used herein the term “obtainable from” means that the protein may be obtained from a plant or may be isolated from milk, or may be obtained from an alternative source, for example by chemical synthesis or enzymatic production. Whereas the term “obtained” as used herein, means that the lactose is directly derived from the milk. For example, in certain embodiments, the lactose can be a natural extract comprising lactose.

According to certain illustrative embodiments, an effective amount of lactose to be used to encapsulate the oil soluble colorant to improving the color stability of said oil soluble colorant in a consumable or to reducing oxidation and/or the development of off-notes of said oil soluble colorant in a consumable, is from about 0.01 to about 1 weight percent, such as about 0.02 to about 0.2 weight percent, such as about 0.1 to about 0.5 weight percent, such as about 0.2 to about 0.8 weight percent, such as about 0.1 to about 0.8 weight percent, or such as 0.09 weight percent of the final weight of the consumable.

According to certain illustrative embodiments, an effective amount of lactose to be used to encapsulate the oil soluble colorant for improving the color stability of said oil soluble colorant in a consumable or to reducing oxidation and/or the development of off-notes of said oil soluble colorant in a consumable is from about 1 weight percent to about 10 weight percent based on the total weight of the consumable, or from about 2 weight percent to about 10 weight percent based on the total weight of the consumable, or from about 3 weight percent to about 10 weight percent based on the total weight of the consumable, or from about 4 weight percent to about 10 weight percent based on the total weight of the consumable, or from about 5 weight percent to about 10 weight percent based on the total weight of the consumable, or from about 6 weight percent to about 10 weight percent based on the total weight of the consumable, or from about 7 weight percent to about 10 weight percent based on the total weight of the consumable, or from about 8 weight percent to about 10 weight percent based on the total weight of the consumable, or from about 9 weight percent to about 10 weight percent based on the total weight of the consumable.

According to certain illustrative embodiments, an effective amount of lactose to be used to encapsulate the oil soluble colorant for improving the color stability of said oil soluble colorant in a consumable or to reducing oxidation and/or the development of off-notes of said oil soluble colorant in a consumable is from about 2 to about 8 weight percent based on the total weight of the consumable, from about 3 to about 7 weight percent based on the total weight of the consumable, or from about 4 to about 6 weight percent based on the total weight of the consumable.

According to certain embodiments, the oil soluble colorant may be encapsulated with one or more plant-derived protein. By way of example, and not in limitation, the plant-derived protein may be derived from algae (such as spirulina, golden chlorella), beans (such as black beans, brown beans, canelli beans, kidney beans, lentil beans, lima beans, pinto beans, soy beans, white beans, mung beans and mixtures thereof), broccoli, mycoprotein, nuts (such as almonds, brazil nuts, cashews, peanuts, pecans, hazelnuts, pine nuts, walnuts and mixtures thereof), peas (such as black eyed peas, chickpeas, green peas, yellow peas, and mixtures thereof), potatoes, seeds (such as canola, chia, flax, hemp, pumpkin, sesame, sunflower and mixtures thereof), plant leaves, cereal (such as oatmeal, wheat, barley, spelt, corn, rice and mixtures thereof) seitain, tempeh, tofu, and mixtures thereof. Illustrative edible plant-derived proteins that may be included in the consumable are pea protein and soy protein.

As will be appreciated by the person skilled in the art, as used herein the term “obtainable from” means that the protein may be obtained from a plant or may be isolated from the plant, or may be obtained from an alternative source, for example by chemical synthesis or enzymatic production. Whereas the term “obtained” as used herein, means that the protein is directly derived from the plant. For example, in certain embodiments, the plant protein can be a natural extract comprising plant proteins.

According to certain embodiments, the at least plant protein is a purified protein from natural origin, for example a purified potato, soy, chick pea, mung bean, pea, corn, wheat or rice protein.

A “purified protein” means one or more proteins of natural or synthetic origin that have a concentration of at least about 80%, at least about 90%, at least about 95%, at least about 99%, or at least about 99.9% of one or more proteins as described before (such as potato, soy, chick pea, mung bean, pea, corn, wheat, rice).

A “protein comprising extract” means any natural extract comprising at least one type of plant protein as described before that may be derived from, for example, but not limited to potato, soy, chick pea, mung bean, pea, corn, wheat, and/or rice.

According to the present invention, the at least one plant protein may be derived from a single source or from multiple sources. According to the present invention, the at least one plant protein comprising extract may be derived from a single source or from multiple sources.

A person of ordinary skill in the art will appreciate that, as used herein, a plant name may refer to the plant as a whole, or to any part of the plant, such as the roots, stem or trunk, bark, leaves, flower, flower stems, or seeds or a combination thereof. These plant parts may be used fresh, or dried, and may be whole, pulverized, mashed, comminuted, or ground up. Extracts from any part or parts of the plant are also contemplated.

Plant protein containing extracts include juices, concentrate juices, dry juices and extracts obtained using solvents such as the ones described previously.

Protein extracts can be obtained using standard extraction methods. Plant Isolates may be extracted using physical means (e.g. grinding, filtration, centrifuge, heating to concentrate), solvent extraction (e.g. with water), or enzymatic processes or—sometimes chemical processes (e.g. acid hydrolysis, esterification) are used to change the chemical nature of the original material. Proteins can further be isolated from the plants by ion exchange. Processing aids can be used such as pH regulators: hydrochloric acid, sodium hydroxide-Elution: citric acid, formic acid.

In a preferred embodiment the solvent is water. In a particular embodiment the protein containing material is incubated with water at a temperature from 50 to 100° C. (such as 50-60° C. or 100° C.). The extraction may be performed using a soxhlet apparatus or by maceration and filtration. The incubation time may be from some hours (such as 10 hours) to 24 hours or more.

Protein comprising extracts may include other compounds that are not proteins such as naturally occurring glicocomponents, polyphenols, salts and sugars.

In a preferred embodiment, the at least one plant protein (such as a purified plant protein) is obtained or obtainable from potato.

Plant proteins may be spray dried extract in the presence of inverted sugar or any other drying support that is well known in the art may be used in this application.

In certain embodiments, the plant protein is a natural extract comprising proteins (such as potato or pea proteins) that comprises (or consist essentially/consist of) at least about 5%, at least about 10%, at least about 15%, at least about 20%, at least about 30%, at least about 40%, at least about 50%, at least about 60%, at least about 70%, at least about 80%, at least about 90%, or at least about 99 w/w % of one or more plant proteins as defined before.

An effective amount of a plant protein (such as, for example a potato or a pea protein) to be used to encapsulate the oil soluble colorant for improving the color stability of said oil soluble colorant in a consumable or to reducing oxidation and/or the development of off-notes of said oil soluble colorant in a consumable, is from about 0.01 weight percent and greater, or about 0.02 weight percent and greater, or about 0.03 weight percent and greater, or about 0.04 weight percent and greater, or about 0.05 weight percent and greater, or about 0.06 weight percent and greater, or about 0.07 weight percent and greater, or about 0.08 weight percent and greater, or about 0.09 weight percent and greater, or about 0.1 weight percent and greater, or about 0.12 weight percent and greater, or about 0.15 weight percent and greater, or about 0.17 weight percent and greater, or about 0.2 weight percent and greater, or about 0.3 weight percent and greater, or about 0.4 weight percent and greater, or about 0.5 weight percent and greater, or about 0.6 weight percent and greater, or about 0.7 weight percent and greater, or about 0.8 weight percent and greater, or about 0.9 weight percent and greater, or about 1 weight percent and greater, or about 1.1 weight percent and greater, or about 1.2 weight percent and greater, or about 1.3 weight percent and greater, or about 1.5 weight percent and greater, based on the total weight of the consumable.

According to certain illustrative embodiments, an effective amount of plant protein to be used to encapsulate the oil soluble colorant for improving the color stability of said oil soluble colorant in a consumable or to reducing oxidation and/or the development of off-notes of said oil soluble colorant in a consumable is from about 0.01 to about 1 weight percent, such as about 0.02 to about 0.2 weight percent, such as about 0.1 to about 0.5 weight percent, such as about 0.2 to about 0.8 weight percent, such as about 0.1 to about 0.8 weight percent, such as 0.09 weight percent of the final weight of the consumable.

According to certain illustrative embodiments, an effective amount of plant protein to be used to encapsulate the oil soluble colorant for improving the color stability of said oil soluble colorant in a consumable or to reducing oxidation and/or the development of off-notes of said oil soluble colorant in a consumable is from about 1 weight percent to about 10 weight percent based on the total weight of the consumable, or from about 2 weight percent to about 10 weight percent based on the total weight of the consumable, or from about 3 weight percent to about 10 weight percent based on the total weight of the consumable, or from about 4 weight percent to about 10 weight percent based on the total weight of the consumable, or from about 5 weight percent to about 10 weight percent based on the total weight of the consumable, or from about 6 weight percent to about 10 weight percent based on the total weight of the consumable, or from about 7 weight percent to about 10 weight percent based on the total weight of the consumable, or from about 8 weight percent to about 10 weight percent based on the total weight of the consumable, or from about 9 weight percent to about 10 weight percent based on the total weight of the consumable.

According to certain illustrative embodiments, an effective amount of plant protein to be used to encapsulate the oil soluble colorant for improving the color stability of said oil soluble colorant in a consumable or to reducing oxidation and/or the development of off-notes of said oil soluble colorant in a consumable is from about 2 to about 8 weight percent based on the total weight of the consumable, from about 3 to about 7 weight percent based on the total weight of the consumable, or from about 4 to about 6 weight percent based on the total weight of the consumable.

In certain embodiments of the encapsulated colorant of the invention or the methods of the present invention, the ratio between the oil soluble colorant and of the at least one of a whey containing proteins, a milk polysaccharide (such as lactose and glycoprotein) and/or a plant protein is of between 1:10 to 10:1. In certain embodiments the ratio between the oil soluble colorant and of the at least one of a whey containing proteins, a milk polysaccharide (such as lactose and glycoprotein) and/or a plant protein is of between 1:10, 1:9, 1:8, 1:7, 1:6, 1:5, 1:4, 1:3, 1:2, 1.1 to 2:1, 3:1, 4:1, 5:1, 6:1, 7:1, 8:1, 9:1 or 10:1.

In certain embodiments of the encapsulated colorant of the invention or the methods of the present invention, a further encapsulation means may be used, including but not limited to one or more of edible gums (such as gum arabic), Starch, modified food starch, saponins (such as quillaja saponins), triacetin, carrageenan, cellulose derivatives, agar gum, maltodextrin, etc.

In certain embodiments of the encapsulated colorant of the invention or the methods of the present invention, the further encapsulation means (such as gum arabic) is mixed to the whey containing protein, the milk polysaccharide (such as lactose and glycoprotein) and/or the plant protein before water is added.

In certain embodiments of the encapsulated colorant of the invention or the methods of the present invention, the ratio of the first encapsulating means (a whey containing protein, a milk polysaccharide and/or a plant protein) and further encapsulating means (such as gum arabic) is between 3:1 to 1:3, such as 1:1.

As “encapsulating means” in the present invention is understood as the first encapsulating means alone (a whey containing protein, a milk polysaccharide and/or a plant protein) or together with the further encapsulating means are defined herein.

In certain embodiments, the ratio oil soluble colorant to the encapsulating mean (including the first and the further encapsulating means, such as for example lactose/gum arabic) is of between 1:10 to 10:1. In certain embodiments the ratio between the oil soluble colorant and of the encapsulating mean (including the first and the further encapsulating means) is of 1:10, 1:9, 1:8, 1:7, 1:6, 1:5, 1:4, 1:3, 1:2, 1.1 to 2:1, 3:1, 4:1, 5:1, 6:1, 7:1, 8:1, 9:1 or 10:1, such as between 5:1 to 1:5, such as 1:3.

In certain embodiments of the encapsulated colorant of the invention or the methods of the present invention, the oil soluble colorant is encapsulated using lactose (first encapsulating means) and gum arabic (further encapsulating means).

In certain embodiments of the encapsulated colorant of the invention or the methods of the present invention, the ratio of lactose and gum arabic is between 3:1 to 1:3, such as 1:1. In certain embodiments, the ratio oil soluble colorant to lactose/gum arabic is between 5:1 to 1:5, such as 1:3.

In certain embodiments of the encapsulated colorant of the invention or the methods of the present invention, the ratio of lactose and gum arabic are 1 part lactose and 1 part gum arabic and the ratio of oil soluble colorant to lactose/gum arabic is 1 part oil soluble colorant and 3 parts lactose/gum arabic.

In certain embodiments of the encapsulated colorant of the invention or the methods of the present invention, the oil soluble colorant is encapsulated using whey protein. In certain embodiments, the whey protein has a % of protein of at least 5%, such as of at least 10%, such as of at least 30% of protein.

In certain embodiments of the encapsulated colorant of the invention or the methods of the present invention, the oil soluble colorant is encapsulated using whey containing protein and gum arabic.

In certain embodiments of the encapsulated colorant of the invention or the methods of the present invention, the ratio of whey containing protein and gum arabic is between 3:1 to 1:3, such as 1:1. In certain embodiments, the ratio oil soluble colorant to whey containing protein/gum arabic is between 5:1 to 1:5, such as 1:3, such as 1:2.

In certain embodiments of the encapsulated colorant of the invention or the methods of the present invention, the ratio of whey containing protein and gum arabic are 1 part whey containing protein and 1 part gum arabic and the ratio of oil soluble colorant to whey containing protein/gum arabic is 1 part oil soluble colorant and 4 parts whey containing protein/gum arabic.

In certain embodiments of the encapsulated colorant of the invention or the methods of the present invention, the oil soluble colorant is encapsulated using whey protein. In certain embodiments, the whey protein has a % of protein of at least 5%, such as of at least 10%, such as of at least 30% of protein.

The encapsulated colorant, may be obtained using one or more of the following encapsulation methods: spray dry, fluid bed, drum drying (film) drying, coacervation, interfacial polymerization, fluid bed processing, disk coating, spray gelation, tape blending, spinning Disc, centrifugal coextrusion, inclusion, miscibility, emulsion stabilization, spray coating, extruded microlipid nanoencapsulation, supercritical fluid microencapsulation, suspension polymerization, cold dehydration, and evaporation dispersion. In certain embodiments, the particle size of the dry encapsulated color can range from 3 to 40 microns, such as from 4, 5, 6, 7, 8, 9, 10,11,12, 13,14,15, 16, 17, 18, 19, 20, 22, 25, 28, 30, 32, 35, 38, 40, to 38, 35, 32, 30, 28, 25, 22, 20, 19, 18, 17, 16, 15, 14, 13, 12, 11, 10, 9, 8, 7, 6, 5, 4 or 3. In certain preferred embodiments, the range is from 5 to 10, or from 15 to 15 such as from 16 to 20.

### Method of Encapsulation

The present invention is also related to a method for preparing an oil soluble colorant having an improved color shelf life, a reduced oxidation and/or a reduced development of off-notes, the method comprising encapsulating an oil soluble colorant with at least one of a whey containing protein, a milk polysaccharide (such as lactose and glycoprotein) and/or a plant protein.

The present invention is also related to the encapsulated colorant obtained according to the encapsulating method of the invention.

The oil soluble colorant may be encapsulated using a method comprising:
a) mixing at least one of: a whey containing protein, a milk polysaccharide (such as lactose and glycoprotein) and/or a plant protein, with an oil soluble colorant, and b) encapsulating the mixture of step (a) using one or more of: spray dry, fluid bed, drum drying, (film) drying, coacervation, interfacial polymerization, fluid bed processing, disk coating, spray gelation, tape blending, spinning Disc, centrifugal coextrusion, inclusion, miscibility, emulsion stabilization, spray coating, extruded microlipid nanoencapsulation, supercritical fluid microencapsulation, suspension polymerization, cold dehydration, and evaporation dispersion; to obtain the encapsulated oil soluble color.

In certain embodiments, several encapsulation methods may be used one after the other.

In certain embodiments the oil soluble colorant may be encapsulated using a method comprising:
a) mixing at least one of: a whey containing protein, a milk polysaccharide (such as lactose and glycoprotein) and/or a plant protein, with an oil soluble colorant, and b) spray drying the mixture of step (a) to obtain the encapsulated oil soluble color.

In certain embodiments, the whey containing protein, the milk polysaccharide (such as lactose and glycoprotein) and/or the plant protein may be premixed with water. In certain embodiments, this mixture with water is mixed to create a homogenous slurry using any mixing means known in the art, including but not limited to high shear mixing.

In step b) the slurry obtained in step a) is spray dried. In certain embodiments the mixture of step a) is continuously mixed while being encapsulated (for example while being spray dried).

In certain embodiments, the solid content of the mixture obtained in step a) is of at least 20%, such as at least 30%, such as at least 40%, such as at least 60%.

In certain embodiments the ratio between the oil soluble colorant and of the at least one of a whey containing protein, a milk polysaccharide (such as lactose and glycoprotein) and/or a plant protein is of between 1:10 to 10:1. In certain embodiments, the ratio between the oil soluble colorant and of the at least one of a whey containing protein, a milk polysaccharide (such as lactose and glycoprotein) and/or a plant protein is of between 1:10, 1:9, 1:8, 1:7, 1:6, 1:5, 1:4, 1:3, 1:2, 1.1 to 2:1, 3:1, 4:1, 5:1, 6:1, 7:1, 8:1, 9:1 or 10:1.

In certain embodiments, a further encapsulation means may be used, including but not limited to one or more of edible gums (such as gum arabic), Starch, modified food starch, saponins (such as quillaja saponins), triacetin, carrageenan, cellulose derivatives, agar gum, maltodextrin, etc.

In certain embodiments, the further encapsulation means (such as gum arabic) is mixed to the whey containing protein, the milk polysaccharide (such as lactose and glycoprotein) and/or the plant protein before water is added. In certain embodiments, this mixture with the further encapsulation means is done after water is added.

In certain embodiments of the encapsulated colorant of the invention or the methods of the present invention, the ratio of the first encapsulating means (a whey containing protein, a milk polysaccharide and/or a plant protein) and further encapsulating means (such as gum arabic) is between 3:1 to 1:3, such as 1:1.

In certain embodiments, the ratio oil soluble colorant to the encapsulating mean (including the first and the further encapsulating means, such as for example lactose/gum arabic) is between 5:1 to 1:5, such as 1:3.

In certain embodiments, the ratio oil soluble colorant to the encapsulating mean (including the first and the further encapsulating means, such as for example lactose/gum arabic) is of between 1:10 to 10:1. In certain embodiments the ratio between the oil soluble colorant and of the encapsulating mean (including the first and the further encapsulating means) is of 1:10, 1:9, 1:8, 1:7, 1:6, 1:5, 1:4, 1:3, 1:2, 1.1 to 2:1, 3:1, 4:1, 5:1, 6:1, 7:1, 8:1, 9:1 or 10:1, such as between 5:1 to 1:5, such as 1:3.

In certain embodiments, the oil soluble colorant is encapsulated using lactose and gum arabic.

In certain embodiments, the ratio of lactose and gum arabic is between 3:1 to 1:3, such as 1:1. In certain embodiments, the ratio oil soluble colorant to lactose/gum arabic is between 5:1 to 1:5, such as 1:3.

In certain embodiments, the ratio of lactose and gum arabic are 1 part lactose and 1 part gum arabic and the ratio of oil soluble colorant to lactose/gum arabic is 1 part oil soluble colorant and 3 parts lactose/gum arabic.

In certain embodiments, the oil soluble colorant is encapsulated using a potato protein(s) and gum arabic.

In certain embodiments, the ratio of potato protein(s) and gum arabic is between 3:1 to 1:3, such as 1:1. In certain embodiments, the ratio oil soluble colorant to potato protein(s)/gum arabic is between 5:1 to 1:5, such as 1:3.

In certain embodiments, the ratio of potato protein(s) and gum arabic are 1 part potato protein(s) and 1 part gum arabic and the ratio of oil soluble colorant to potato protein(s)/gum arabic is 1 part oil soluble colorant and 3 parts potato protein(s)/gum arabic.

In certain embodiments, the oil soluble colorant is encapsulated using a method comprising a) mixing lactose, gum arabic and water with an oil soluble colorant and b) spray drying the mixture of step (a) to obtain the encapsulated oil soluble color. In certain embodiments the mixture of step a is mixed using high shear. In certain embodiments, the ratio of lactose and gum arabic is between 3:1 to 1:3, such as 1:1. In certain embodiments, the ratio oil soluble colorant to lactose/gum arabic is between 5:1 to 1:5, such as 1:3.

In certain embodiments, the ratio of lactose and gum arabic are 1 part lactose and 1 part gum arabic and the ratio of oil soluble colorant to lactose/gum arabic is 1 part oil soluble colorant and 3 parts lactose/gum arabic. In certain embodiments, the solid content of the slurry is approximately 35% solids. In certain embodiments, is step b) the slurry is continuously mixed while being spray dried.

In certain embodiments, the oil soluble colorant is encapsulated using a whey protein. In certain embodiments, the whey protein has a % of protein of at least 5%, such as of at least 10%, or such as of at least 30% of protein.

In certain embodiments, the oil soluble colorant is encapsulated using a method comprising a) mixing whey protein with an oil soluble colorant and b) spray drying the mixture of step (a) to obtain the encapsulated oil soluble color. In certain embodiments, the at least one of a whey protein are premixed with water previously to be mixed with the oil soluble color. In certain embodiments the mixture of step a) is mixed using high shear. In certain embodiments, the ratio oil soluble colorant to a whey protein is between 5:1 to 1:5, such as 1:33.

In certain embodiments, the oil soluble colorant is encapsulated using a method comprising a) mixing whey containing protein, gum arabic and water with an oil soluble colorant and b) spray drying the mixture of step (a) to obtain the encapsulated oil soluble color. In certain embodiments the mixture of step a is mixed using high shear. In certain embodiments, the ratio of whey containing protein and gum arabic is between 3:1 to 1:3, such as 1:1. In certain embodiments, the ratio oil soluble colorant to whey containing protein/gum arabic is between 10:1 to 1:7, such as 7:1 to 1:7, such as 5:1 to 1:5, such as 1:4.

In certain embodiments, the ratio of lactose and gum arabic are 1 part lactose and 1 part gum arabic and the ratio of oil soluble colorant to lactose/gum arabic is 1 part oil soluble colorant and 4 parts lactose/gum arabic. In certain embodiments, the solid content of the slurry is approximately 35% solids. In certain embodiments, is step b) the slurry is continuously mixed while being spray dried. In certain embodiments, an antioxidant as described herein may be added in step a) and/or in step b).

In certain embodiments, the solid content of the slurry is approximately 30% solids. In certain embodiments, is step b) the slurry is continuously mixed while being spray dried.

In certain embodiments, the particle size of the dry encapsulated color can range from 3 to 40 microns, such as from 4, 5, 6, 7, 8, 9, 10,11,12, 13, 14, 15, 16, 17, 18, 19, 20, 22, 25, 28, 30, 32, 35, 38, 40, to 38, 35, 32, 30, 28, 25, 22, 20, 19, 18, 17, 16, 15, 14, 13, 12, 11, 10, 9, 8, 7, 6, 5, 4 or 3. In certain preferred embodiments, the range is from 5 to 10, or from 15 to 15 such as from 16 to 20.

The method of improving the color stability of an oil soluble colorant in a consumable of the invention comprises adding to a consumable base an effective amount of an oil soluble colorant encapsulated as described herein.

The encapsulated oil soluble colorant according to the invention is added to a consumable base to provide the desired color. The invention is thus related to a consumable comprising the encapsulated colorant of the invention.

The consumable where the encapsulated oil soluble colorant according to the invention is added includes but is not limited to i) oil coatings, oil slurries, powdered blends, seasonings and/or spice blends comprising color(s); ii) edible snack foods including but not limited to extruded snacks, rise snacks, corn snacks, rise and corn snacks, popcorn cakes, chips and crisps, puffed snacks, popped popcorn, tortilla and corn chips, nuts and/or seed based snacks, pretzels, protein-based snacks, dairy-based snacks, meat-based snacks and jerkies, plant based snacks, crackers, dried fruit and/or vegetable snacks, grain-based snacks, cookies, iii) baked snacks including but not limited to breads, doughs, breadsticks, cookies, doughnuts, cakes, breadings, coatings, bagels, pasta and noodles.

The addition of the encapsulated color according to the invention to the consumable base will depend on the color intensity and color hue and the nature of the consumable that has to be colored and can be defined by the expert in the art. Thus, in certain embodiments, the addition of the encapsulated color according to the invention to the consumable base will be directly or via the addition of the powdered color to a seasoning mix or oil slurry that is applied to the consumable. In certain embodiments the addition of the encapsulated color according to the invention to the consumable base is before any cooking or backing. In certain embodiments the addition of the encapsulated color according to the invention to the consumable base is at the surface of the consumable or is mixed homogenously with said consumable base.

The consumable may include at least one fat. The at least one fat may be selected from animal-derived fats, plant-derived fats and mixtures thereof. Suitable animal fats include animal-derived butter fats, milk fats, lard, and the like, and mixtures thereof. Without limitation, for example, the animalic fat may be derived from chicken, cow, duck, goose, pig and mixtures thereof.

The consumable may further include at least one sweetener in a sweetening-effective amount to impart a desired sweetness to the consumable to which the sweetener is added. The at least one sweetener may comprise at least one caloric sweetener, or at least one non-caloric sweetener, or a combination of at least one caloric sweetener and at least one non-caloric sweeteners. The non-caloric sweeteners may be selected from synthetic non-caloric sweeteners and natural non-caloric sweeteners.

The consumable may further include nutritionally effective amounts of at least one vitamin, or at least one mineral or a combination of at least one vitamin and at least one mineral. According to certain embodiments, the consumable comprises a nutritionally effective amount of at least one vitamin.

The consumable may further include a sufficient amount of at least one preservative or ingredient for pH adjustment to prevent decomposition and/or microbial growth and maintain physical stability of the finished product.

Also disclosed is a method for preparing a consumable product such as snacks having an improved color shelf life, a reduced oxidation and/or reduced development of off-notes. The method comprises combining a consumable base with an effective amount of an oil soluble colorant encapsulated with at least one of a whey containing protein, a milk polysaccharide (such as lactose and glycoprotein) and/or a plant protein (encapsulated oil soluble colorant of the invention) as described herein. In certain embodiments of the encapsulated colorant of the invention or the methods of the present invention, a further encapsulation means may be used, including but not limited to one or more of edible gums (such as gum arabic), Starch, modified food starch, saponins (such as quillaja saponins), triacetin, carrageenan, cellulose derivatives, agar gum, maltodextrin, etc.

According to certain illustrative embodiments, the method comprises combining a consumable base with an effective amount of an oil soluble colorant encapsulated with at least one of a whey containing protein, a milk polysaccharide (such as lactose and glycoprotein) and/or a plant protein to improve the color shelf life, to reduce oxidation and/or reduce development of off-notes of the consumable. In the present invention, “combining a consumable base with an effective amount of an oil soluble colorant encapsulated” is understood as any way known in the art of adding, combining, or mixing the encapsulated oils soluble colorant of the invention to the consumable base and it will change depending on the nature of the consumable.

The consumable or food product encompasses the following general food categories, as defined by the Food and Drug Administration (FDA): baked goods and baking mixes, including all ready-to-eat and ready-to-bake products, already backed products like patisserie and cakes, flours, and mixes requiring preparation before serving; beverages, alcoholic, including malt beverages, wines, distilled liquors, and cocktail mix; beverages and beverage bases, non-alcoholic, including only special or spiced teas, soft drinks, coffee substitutes, and fruit and vegetable flavored gelatin drinks; breakfast cereals, including ready-to-eat and instant and regular hot cereals; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavored frosting, marshmallows, baking chocolate, and brown, lump, rock, maple, powdered, and raw sugars; dairy product analogs, including nondairy milk, frozen or liquid creamers, coffee whiteners, toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh fruits and fruit juices, including only raw fruits, citrus, melons, and berries, and home-prepared “ades” and punches made therefrom; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; fresh vegetables, tomatoes, and potatoes, including only fresh and home-prepared vegetables; frozen dairy desserts and mixes, including ice cream, ice milks, sherbets, and other frozen dairy desserts and specialties; fruit and water ices, including all frozen fruit and water ices; gelatins, puddings, and fillings, including flavored gelatin desserts, puddings, custards, parfaits, pie fillings, and gelatin base salads; grain products and pastas, including macaroni and noodle products, rice dishes, and frozen multicourse meals, without meat or vegetables; gravies and sauces, including all meat sauces and gravies, and tomato, milk, buttery, and specialty sauces; hard candy and cough drops, including all hard type candies; herbs, seeds, spices, seasonings, blends, extracts, and flavorings, including all natural and artificial spices, blends, and flavors; jams and jellies, home-prepared, including only home-prepared jams, jellies, fruit butters, preserves, and sweet spreads; jams and jellies, commercial, including only commercially processed jams, jellies, fruit butters, preserves, and sweet spreads; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavored milks and milk drinks, dry milks, toppings, snack dips, spreads, weight control milk beverages, and other milk origin products; nuts and nut products, including whole or shelled tree nuts, peanuts, coconut, and nut and peanut spreads; plant protein products, including the National Academy of Sciences/National Research Council “reconstituted vegetable protein” category, and meat, poultry, and fish substitutes, analogs, and extender products made from plant proteins; poultry products, including all poultry and poultry-containing dishes, salads, appetizers, frozen multicourse poultry meals, and sandwich ingredients prepared by commercial processing or using commercially processed poultry with home preparation; processed fruits and fruit juices, including all commercially processed fruits, citrus, berries, and mixtures; salads, juices and juice punches, concentrates, dilution, “ades”, and drink substitutes made therefrom; processed vegetables and vegetable juices, including all commercially processed vegetables, vegetable dishes, frozen muiticourse vegetable meals, and vegetable juices and blends; snack foods, including chips, pretzels, and other novelty snacks; soft candy, including candy bars, chocolates, fudge, mints, and other chewy or nougat candies; soups, home-prepared, including meat, fish, poultry, vegetable, and combination home-prepared soups; soups and soup mixes, including commercially prepared meat, fish, poultry, vegetable, and combination soups and soup mixes; sugar, white, granulated, including only white granulated sugar; sugar substitutes, including granulated, liquid, and tablet sugar substitutes; and sweet sauces, toppings, and syrups, including chocolate, berry, fruit, corn syrup, and maple sweet sauces and toppings.

Without limitation, and only by way of illustration, the consumable may be selected from i) oil coatings, oil slurries, powdered blends, seasonings and/or spice blends comprising color(s); ii) edible snack foods including but not limited to extruded snacks, rise snacks, corn snacks, rise and corn snacks, popcorn cakes, chips and crisps, puffed snacks, popped popcorn, tortilla and corn chips, nuts and/or seed based snacks, pretzels, protein-based snacks, dairy-based snacks, meat-based snacks and jerkies, plant based snacks, crackers, dried fruit and/or vegetable snacks, grain-based snacks, cookies, iii) baked snacks including but not limited to breads, doughs, breadsticks, cookies, doughnuts, cakes, breadings, coatings, bagels, pasta and noodles.

According to certain embodiments, the consumable is a product that is considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

The CIELAB color space, also known as the L*a*b* color space was developed by the Commission Internationale de L′Eclairage (abbreviated “CIE”). The color compositions and the consumables of the present disclosure can be analyzed with a spectrophotometer, and CIELAB L*a*b* values can be calculated from the spectral data, as described in greater detail below. The L*a*b* values provide a means of representing color characteristics and assessing the magnitude of difference between two colors. The L*a*b* values also provide a means of representing color characteristics and assessing the magnitude of difference between two colors not only of solutions, but also of products. Measurements of color of consumables in solid form are accomplished using reflectance measurements from the surface of the consumable.

For example, L*a*b* values consist of a set of coordinate values defined in a three-dimensional Cartesian coordinate system. L* is the lightness coordinate and provides a scale of lightness from black (0 L* units) to white (100 L* units) on a vertical axis. a* and b* are coordinates related to both hue and chroma. a* provides a scale for greenness (−a* units) to redness (+a* units), with neutral at the center point (0 a* units), on a horizontal axis; b* provides a scale for blueness (−b* units) to yellowness (+b* units), with neutral at the center point (0 b* units), on a second horizontal axis perpendicular to the first horizontal axis. The three axes cross where L* has a value of 50 and a* and b* are both zero. A color difference can be defined by a numerical comparison of a sample color to a standard color, such as the CIE Standard Illuminant D65.

ΔE is a measure of the magnitude of total color difference between two colors represented in CIELAB L*a*b* color space. It has been reported that an experienced color observer cannot distinguish any difference between two colors when the ΔE is about 2.3 or less. The ΔE of two different colors with L*a*b* values, L*₁a*₁b*₁ and L*₂a*₂b*₂, is calculated using Equation 1:

$$Δ {E}_{ab}^{*} = \sqrt{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}} \qquad Equation 1$$

### FIGURES

FIG. 1. The antioxidants tested in this system included Acerola (AA), Carnosic Acid (CA), and Mixed Tocopherols (MT).

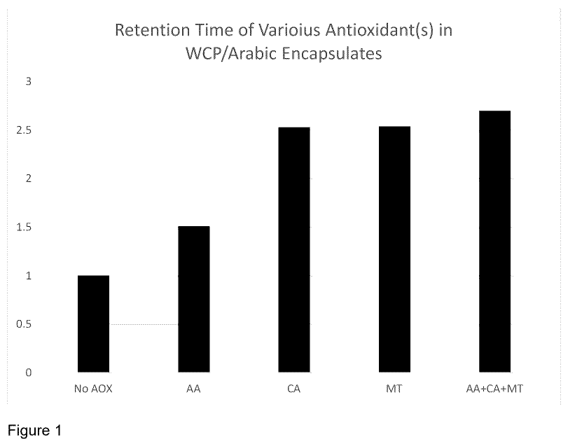

### EXAMPLES

The following examples are given solely for the purpose of illustration and are not to be construed as limitations of the present disclosure, as many variations of the invention are possible without departing from the spirit and scope of the present disclosure.

### Example 1

### Inventive Example 1—Encapsulation with Whey

1) Oil soluble colorant (paprika oleoresin) is added to a prehydrated blend of sweet dry whey powder (with 12% of proteins) and water under high shear to create a homogenous slurry (8.5% w/w of paprika oleoresine). The ratio of color (paprika oleoresin) to whey is 1 Part oil and 3.33 parts Whey. The solid content of the slurry is approximately 30% solids. Other trials with 50-60% w/w solids were also done.
2) Slurry is continuously mixed while being spray dried using a standard spray nozzle.
3) The resulting powdered color is applied to a snack food either directly or via the addition of the powdered color to a seasoning mix or oil slurry that is applied to the snack food.

Sweet Dry Whey is used at 75% of the color encapsulate. The colored encapsulate is dried and blended with a seasoning & oil slurry before being applied to the snack. The actual amount of sweet dry whey used in the snack is 0.17%. It was observed that higher whey proteins work better.

### Inventive Example 2—Encapsulation with Lactose/Gum Arabic

1) Oil soluble colorant (paprika oleoresin) is added to a prehydrated blend of lactose (1% w/w lactose protein) and gum arabic and water under high shear to create a homogenous slurry. The ratio of lactose & gum arabic are 1 part lactose and 1 part gum arabic. The ratio of oil soluble colorant to lactose/gum arabic is 1 Part oil and 3 parts lactose/gum arabic. The solid content of the slurry is approximately 35% solids. Other trials with 50-60% w/w solids were also done.
2) Slurry is continuously mixed while being spray dried using a standard spray nozzle.
3) The resulting powdered color is applied to a snack food either directly or via the addition of the powdered color to a seasoning mix or oil slurry that is applied to the snack food.

For example, lactose is used at 37.5% of the colored encapsulate. The colored lactose encapsulate is dried and blended with a seasoning & oil slurry before being applied to the snack. After dilution in the oil slurry, the actual amount of lactose used in the snack is 0.085%.

### Inventive Example 3—Encapsulation with Potato Protein and Gum Arabic

Potato protein isolate with ~90% protein was used to encapsulate an oil soluble colorant (paprika oleoresin) Encapsulation was done as described in inventive example 2. The ration between potato protein and gum arabic is 1:1 The high protein in the isolate made the encapsulates even better. The potato protein isolate was 37.5% of the weight of the dry color encapsulate. The dry color encapsulate is added to a seasoning blend at 1.8%. The colored potato protein encapsulate is dried and blended with a seasoning & oil slurry before being applied to the snack. After dilution in the oil slurry, the actual amount of lactose used in the snack is 0.085%. The ratio of oil to potato protein & gum arabic is of 1:3.

### Inventive Example 4—Encapsulation with Whey Containing Protein/Gum Arabic

1) Oil soluble colorant is added to a prehydrated blend of whey containing protein and gum arabic and water under high shear to create a homogenous slurry. The ratio of whey containing protein & gum arabic are 1 part whey containing protein and 1 part gum arabic. The ratio of oil soluble colorant to whey containing protein/gum arabic is 1 Part oil and 4 parts whey containing protein/gum arabic. The solid content of the slurry is approximately 35% solids. Other trials with 50-60% w/w solids were also done.
2) Slurry is continuously mixed while being spray dried using a standard spray nozzle.
3) The resulting powdered color is applied to a snack food either directly or via the addition of the powdered color to a seasoning mix or oil slurry that is applied to the snack food.

For example, whey containing protein is used at 40% of the colored encapsulate. The colored whey containing protein encapsulate is dried and blended with a seasoning & oil slurry before being applied to the snack. After dilution in the oil slurry, the actual amount of whey containing protein used in the snack is 0.08%.

### Example 2. Sensory Evaluation

Encapsulated colors were tested in an extruded snack food application. Extruded snack base was made using 100% corn grits and extruded into small pieces approximately ¾″ Length×0.5″ diameter in size using an industrial short barrel extruder at 100 Kg/Hour. Each color encapsulation variable was prepared and topically applied to the snack matrix using either an oil or spray dried seasoning and oil coating as the delivery vector. Samples were tested and compared to a negative and positive control. The negative control sample was prepared by coating the extruded snack pieces with non-encapsulated paprika oleoresin color using an oil coating as the delivery vector. The positive control sample was prepared by coating the extruded snack pieces with a blend of tartrazine (FD&C yellow #5) and sunset yellow (FD&C yellow #6) using a spray dried seasoning blend as the delivery vector. Sensory Tests were carried out at time 0 and 2-weeks post aging at 32° C.

Eight (8) expert panelists were asked to evaluate samples for intensity of off-flavors.

### Least Predominance of Off-Flavors

Samples were ranked by panelists in order of increasing off-flavors detected in the samples.

Prior to aging, Sensory Analysis of Fresh samples indicated that 80.0% of panelists identified the negative control sample as having the least predominance of off-flavors while 20.0% of panelists identified sample 569 as having the least predominance of off-flavors. None of the panelists identified sample 521 as having the least predominance of off-flavors.

Alternatively, following 2-weeks aging at 32C, predominance of off-flavors shifted significantly when evaluated by panelists. Only 16.7% of panelists described the negative control sample as having least predominance of off-flavors, while 50.0 percent of panelist identified sample 569 as having the least predominance of off-flavors, and 33.3% of panelist identified sample 521 as having the least predominance of off-flavors.

TABLE 1

| Least Predominance of Off-Flavors % of panelists | | | |
|---|---|---|---|
| | Fresh | 2-wk 32° C. | Net Change |
| Negative Control | 80.0 | 16.7 | −63.3% |
| Encapsulated Sweet Dry Whey 569 | 20.0 | 50.0 | 30.0% |
| Encapsulated Lactose/Arabic 521 | 0.0 | 33.3 | 33.3% |

In summary, when stored for 2-weeks at 32° C. the identification of the negative control sample as having the “least predominance of off-flavors” decreased by over 60% while selection of colors encapsulated with either sweet dry whey or lactose and gum Arabic saw net gains by 30.0% and 33.3% respectively (Table 1).

### Most Predominance of Off-Flavors

Samples were ranked by panelists in order of decreasing off-flavors detected in the samples. Prior to aging, Sensory Analysis of Fresh samples indicated that none of panelists identified the negative control sample as having the most predominance of off-flavors while 50% of panelists identified sample 569 as having the most predominance of off-flavors and 50.0% of panelist identified sample 521 as having the most predominance of off-flavors.

Alternatively, following 2-weeks aging at 32C, 60.0% of panelists described the negative control sample as having most predominance of off-flavors, and none of panelists described sample 569 as having the most predominance of off-flavors, and 32.0% of panelists identified sample 521 as having the most predominance of off-flavors.

TABLE 2

| Sample with Most Off-Flavors % of panelists | | | |
|---|---|---|---|
| | Fresh | 2-wk 32° C. | Net Change |
| Negative Control | 0.0 | 60.0 | 60.0% |
| Encapsulated Sweet Dry Whey 569 | 50.0 | 0.0 | −50.0% |
| Encapsulated Lactose/Arabic 521 | 50.0 | 32.0 | −10.0% |

In summary, when stored for 2-weeks at 32° C., the identification of the negative control sample as having the “Most Off-Flavors” increased by over 60% while selection of colors encapsulated with either sweet dry whey or lactose and gum Arabic decreased by 50.0% and 10.0% respectively (Table 2).

### Sensory Procedure: Most Similar to Control

Panelist were asked to identify the sample that was most similar to a positive control sample made with FD&C colors tartrazine (FD&C yellow #5) and sunset yellow (FD&C yellow #6). Prior to aging, Sensory Analysis of fresh samples indicated that 67.7% of panelists identified the negative control sample as being the most similar to the positive control sample while 33.3% of panelists identified sample 569 as being the most similar and none of panelist identified sample 521 as being the most similar.

Alternatively, following 2-weeks aging at 32° C., none of panelists identified the negative control as being the most similar to the positive control sample, and 32.0% of panelists described sample 569 as being the most similar, and 60.0% of panelists identified sample 521 as being the most similar.

TABLE 3

| Sample Closest to Positive Control % of panelists | | | |
|---|---|---|---|
| | Fresh | 2-wk 32° C. | Net Change |
| Negative Control | 67.7 | 0.00 | −67.7% |
| Encapsulated Sweet Dry Whey 569 | 33.3 | 40.0 | 6.7% |
| Encapsulated Lactose/Arabic 521 | 0.0 | 60.0 | 60.0% |

In summary, when stored for 2-weeks at 32° C., the identification of the negative control sample as being the most similar to the control decreased by over 67% while selection of colors encapsulated with either sweet dry whey or lactose and gum Arabic increased by 6.7% and 60.0% respectively (Table 3).

### Color Analysis:

Three-dimensional color measurements were taken after snack pieces were coated with each corresponding variable using a Canon CIE L a b color measurement. Color intensity for the negative control was lighter than the corresponding lactose/gum arabic and sweet dry whey encapsulated counterparts as indicated by higher L values. Additionally, color samples of the negative control were less red as indicated by lower a values when compared to the lactose/gum arabic and sweet dry whey encapsulated counterparts (table 4).

TABLE 4
CIE LAB L values indicating lightness

| Sample ID | CIE L value |
|---|---|
| Negative Control | 63.64 |
| Encapsulated Sweet Dry Whey 521 | 49.24 |
| Encapsulated Lactose/Arabic 569 | 57.50 |

### Plant (Potato Protein) Sensory Evaluation.

Potato Encapsulated color (Inventive Example 3) was tested in an extruded snack food application. Extruded snack base was made using 100% corn grits and extruded into small pieces approximately ¾″ Length×0.5″ diameter in size using an industrial short barrel extruder at 100 Kg/Hour. Each color encapsulation variable was prepared and topically applied to the snack matrix using either an oil or spray dried seasoning and oil coating as the delivery vector. Samples were tested and compared to a negative and positive control. The negative control sample was prepared by coating the extruded snack pieces with non-encapsulated paprika oleoresin color using an oil coating as the delivery vector. The positive control sample was prepared by coating the extruded snack pieces with a blend of tartrazine (FD&C yellow #5) and sunset yellow (FD&C yellow #6) using a spray dried seasoning blend as the delivery vector. Sensory Tests were carried out at 2-weeks post aging at 32° C. Eight (8) expert panelists were asked to evaluate samples for intensity of off-flavors.

### Most Predominance of Off-Flavors

Samples were ranked by panelists for having the MOST off-flavors following 2-weeks aging at 32° C. indicate 50% of panelists identified the negative control sample as having the most predominance of off-flavors while only 33.3% of panelists identified sample the protein encapsulated sample E as having the most predominance of off-flavors (see Table 5).

TABLE 5
Sample with Most Off-Flavors after 2-wk 32° C. % of panelists

| | |
|---|---|
| Negative Control | 50.0 |
| Encapsulated Potato Protein “E” | 33.3 |
| Positive Control | 16.7 |

In summary, when stored for 2-weeks at 32° C., the identification of the negative control sample as having the “Most Off-Flavors” was identified by 50.0% of panelists while selection of colors encapsulated potato protein was only identified by 33.3% of the time.

### Color Analysis:

Three-dimensional color measurements were taken after snack pieces were coated with each corresponding variable using a Canon CIE L a b color measurement. Color intensity for the negative control was lighter than the corresponding potato protein/gum arabic encapsulated counterparts as indicated by higher L values. Additionally, color samples of the negative control were less red as indicated by lower a values when compared to the potato protein/gum arabic encapsulated products (see tables 6 and 7).

TABLE 6
CIE LAB L values indicating lightness

| Sample ID | CIE L value |
|---|---|
| Negative Control | 63.64 |
| Encapsulated Potato Protein/Arabic “E” | 53.80 |

TABLE 7
CIE LAB “a” values indicating redness

| Sample ID | CIE a value |
|---|---|
| Negative Control | 29.08 |
| Encapsulated Potato Protein/Arabic “E” | 38.20 |

### Example 3

Encapsulation of a paprika oleoresine was done as described in inventive example 4 with the modification that several antioxidants were added to the oleoresine.

The antioxidants tested in this system included Acerola (AA), Carnosic Acid (CA), and Mixed Tocopherols (MT).

Antioxidants were added to the color and applied to the puffs in the following percentages to the finished product:

StabilEnhance® OSR 20 (rosemary extract with 20% Carnosic Acid) used at 0.0008%

Mixed Natural Tocopherols used at 0.0014%

Acerola Juice Powder (17% Vitamin C) at 0.00031%

Oxidation was measured using Velp Scientifica Oxitest. Velp Scientifica Oxitest measures oxygen consumption/antioxidant efficiency under controlled temperature and oxygen conditions, thus determining the retention time of different antioxidants. A higher retention time is associated with slower oxidation rates and better stability. The Velp Scientifica Oxitest retention time results demonstrated that addition of any antioxidant either singularly or in combination, in sufficient quantity was associated with higher retention times in the Oxitest and thus the addition of these antioxidants was deemed to be beneficial to the stability of the encapsulated color. The retention times for these are given in the table 1.

It was found that a combination of Acerola Juice, Carnosic Acid and Mixed Tocopherols when added to the dry encapsulated oleoresin color in the same quantities had a greater retention time than any single component.

While the compositions, process for making for the compositions, process for using the compositions, and the consumables have been described above in connection with certain illustrative embodiments, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. An oil soluble colorant encapsulated with at least one of: a whey containing protein, a milk polysaccharide and/or a plant protein.

2. The encapsulated oil soluble colorant according to claim 1, wherein for encapsulating the oil soluble colorant further encapsulating means are used selected from one or more of: edible gums, starch, modified food starch, saponins, triacetin, carrageenan, cellulose derivatives, agar gum, and maltodextrin.

3. The encapsulated oil soluble colorant according to claim 1, wherein the oil soluble colorant is of natural origin or of synthetic origin.

4. The encapsulated oil soluble colorant according to claim 1, wherein the oil soluble colorant is selected from one or more of; Astaxanthin and Astaxanthin derivatives, bixin and annatto extracts, carotenes tagetes, saffron, crocin and crocetin based colorants and their derivatives, chlorophyll containing colorants and derivatives, paprika based colorants paracoccus pigments, red yeast and phaffia based colorants and derivatives, algal based pigments, lycopene based colorants, turmeric and turmeric oleoresin, and microbial based pigments.

5. The encapsulated oil soluble colorant according to claim 1, wherein the ratio between the oil soluble colorant and the at least one of a whey containing protein, a milk polysaccharide and/or a plant protein is between 1:10 to 10:1.

6. The encapsulated oil soluble colorant according to claim 1, wherein the plant protein or proteins are selected from one or more of potato protein, lentil protein, bean proteins, seed proteins, grain proteins, nut proteins, macro and micro-algal based proteins.

7. The encapsulated oil soluble colorant according to claim 1, further comprising one or more antioxidants.

8. A method for making the encapsulated oil soluble colorant according to claim 1, the method comprising:
a) mixing at least one of: a whey containing protein, a milk polysaccharide and glycoprotein and/or a plant protein, with an oil soluble colorant; and
b) encapsulating the mixture of step (a) using one or more of: spray dry, fluid bed, drum drying, film drying, coacervation, interfacial polymerization, fluid bed processing, disk coating, spray gelation, tape blending, spinning Disc, centrifugal coextrusion, inclusion, miscibility, emulsion stabilization, spray coating, extruded microlipid nanoencapsulation, supercritical fluid microencapsulation, suspension polymerization, cold dehydration, and evaporation dispersion; to obtain the encapsulated oil soluble color.

9. The method according to claim 8, wherein for encapsulating the oil soluble colorant, further encapsulating means are used selected from one or more of edible gums, starch, modified food starch, saponins, triacetin, carrageenan, cellulose derivatives, agar gum, and maltodextrin.

10. The method according to claim 8, wherein in step a) and/or in step b) one or more antioxidants are added.

11. A method for preparing an oil soluble colorant having an improved color shelf life, a reduced oxidation and/or reduced development of off-notes, the method comprising encapsulating an oil soluble colorant with at least one of a whey containing protein, a milk polysaccharide, and/or a plant protein.

12. The method according to claim 11, wherein for encapsulating the oil soluble colorant further encapsulating means are used selected from one or more of; edible gums, starch, modified food starch, saponins, triacetin, carrageenan, cellulose derivatives, agar gum, and maltodextrin.

13. The method according to claim 11, further comprising the addition of one or more antioxidants.

14. (canceled)

15. The method according to claim 8, wherein the oil soluble colorant is selected from one or more of: Astaxanthin and Astaxanthin derivatives, bixin and annatto extracts, carotenes tagetes, saffron, crocin and crocetin based colorants and their derivatives, chlorophyll containing colorants and derivatives, paprika based colorants, paracoccus pigments, red yeast and phaffia based colorants and derivatives, algal based pigments, lycopene based colorants turmeric and turmeric oleoresin, and microbial based pigments.

16. The method according to claim 8, wherein the ratio between the oil soluble colorant and the at least one of a whey containing protein, a milk polysaccharide and/or a plant protein is between 1:10 to 10:1.

17. An oil soluble colorant encapsulated according to the method of claim 8.

18. A method of improving the color stability of an oil soluble colorant in a consumable comprising adding to a consumable base an effective amount of an encapsulated oil soluble colorant according to claim 1.

19. (canceled)

20. A method of reducing oxidation and/or the development of off-notes of an oil soluble colorant in a consumable comprising adding to a consumable base an effective amount of an encapsulated oil soluble colorant according to claim 1.

21. A method for preparing a consumable product having an improved color shelf life, a reduced oxidation and/or reduced development of off-notes, the method comprising combining a consumable base with an effective amount of an encapsulated oil soluble colorant according to claim 1.

22-24. (canceled)
